(19) United States
(12) Patent Application Publication
(10) Pub. No.: US 2017/0200203 A1
(43) Pub. Date: Jul. 13, 2017

(54) ITEM DETECTION BASED ON TEMPORAL IMAGING ANALYSIS

(71) Applicant: Lenovo (Singapore) Pte. Ltd., Singapore (SG)

(72) Inventors: Timothy Winthrop Kingsbury, Cary, NC (US); Bradley Park Strazisar, Cary, NC (US); Brian Allen Burdette, Apex, NC (US); Joaquin F. Luna, Durham, NC (US)

(21) Appl. No.: 14/991,749

(22) Filed: Jan. 8, 2016

(51) Int. Cl. G06Q 30/02; G06K 9/00; G06K 9/62

(52) U.S. Cl. CPC G06Q 30/0281; G06K 9/6215; G06K 9/00771; G06K 9/00832

(57) ABSTRACT

A method includes obtaining a first image of an area to be used by a customer prior to the customer occupying the area, obtaining a second image of the area after the customer has left the area, analyzing the first and second images via an information handling system to determine significant differences resulting from the customer occupying the area, and providing a notification via the information handling system regarding the significant differences to enable the differences to be addressed.

### BACKGROUND

When traveling via rental car, taxi cab, or other vehicle such as a passenger jet or train, it is common for customers to accidentally leave their belongings behind. The left behind belongings may be found by a driver of the vehicle, or others, and if the customer is still within sight, the belongings may be returned immediately. If the left behind belongings are not noticed by the driver or others while the customer is still within sight, the belongings may be turned in to a lost and found, thrown away, or otherwise disposed of.

### SUMMARY

A method includes obtaining a first image of an area to be used by a customer prior to the customer occupying the area, obtaining a second image of the area after the customer has left the area, analyzing the first and second images via an information handling system to determine significant differences resulting from the customer occupying the area, and providing a notification via the information handling system regarding the significant differences to enable the differences to be addressed.

A computing device includes a processor and a memory device coupled to the processor having instructions stored thereon. The instructions are executable by the processor to obtain a first image of an area to be used by a customer prior to the customer occupying the area, obtain a second image of the area after the customer has left the area, analyze the first and second images via an information handling system to determine significant differences resulting from the customer occupying the area, and provide a notification via the information handling system regarding the significant differences to enable the differences to be addressed.

A machine readable storage device has instructions that are executable by a processor to perform operations. The operations include obtaining a first image of an area to be used by a customer prior to the customer occupying the area, obtaining a second image of the area after the customer has left the area, analyzing the first and second images via an information handling system to determine significant differences resulting from the customer occupying the area, and providing a notification via the information handling system regarding the significant differences to enable the differences to be addressed.

### BRIEF DESCRIPTION OF THE DRAWINGS

FIG. 1 is a top view of an area inside of a vehicle according to an example embodiment.

FIG. 2 is a flowchart illustrating a computer implemented method of detecting items left behind by a customer according to an example embodiment.

FIG. 3 is an example of device circuitry for performing methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

One or more pre-use images of an area to be used by a customer are captured prior to use by the customer. The area may be a seating area in a vehicle such as an automobile, train seat, airplane seat, conference room, restaurant, theater, or other area including an area with assigned seating. Use may include actual occupancy by the user and in addition, use of storage space, such as a trunk or overhead shelf or bin associated with the seating area. One or more cameras may be used to provide the one or more images. The cameras may be positioned to capture images of portions of the area where customer items are likely to be left behind when the customer ceases using the area.

Once the customer ceases using the area, one or more post-use images of the area are captured and compared to the pre-use images to determine whether there are significant differences in the area which might be representative of an item being left behind. The image differences may be identified and processed via image analytics to identify items in the post-use images that were not in the pre-use images. This may referred to as a temporal imaging analysis. The identification may including identifying the one or more items as a wallet, purse, cell phone, tablet, backpack, ring, key, credit card, or other type of item, which is categorized as significant. Other items that may not be specifically identified may be categorized as significant may include items that exceed a specified size minimum. In further embodiments, significant differences may include damage to the area.

When one or more significant differences are identified, a notification may be provided. If the significant differences are related to an item left behind by a customer, an audible sound such as a tone or oral warning, or a visual alert may be issued to alert the customer. The images may be time stamped in some embodiments, and correlated with a known customer and means of electronically contacting the customer such as a cell phone number or email address. An electronic communication such as an SMS message or email may also be sent to the customer and/or owner or operator of the area. The electronic message may contain a description of the item or items, or may contain a link to a networked storage location where a picture of the area may be seen. If the significant differences relate to damage to the area such as liquid stains or physical damage, an owner or operator of the area may receive the notification.

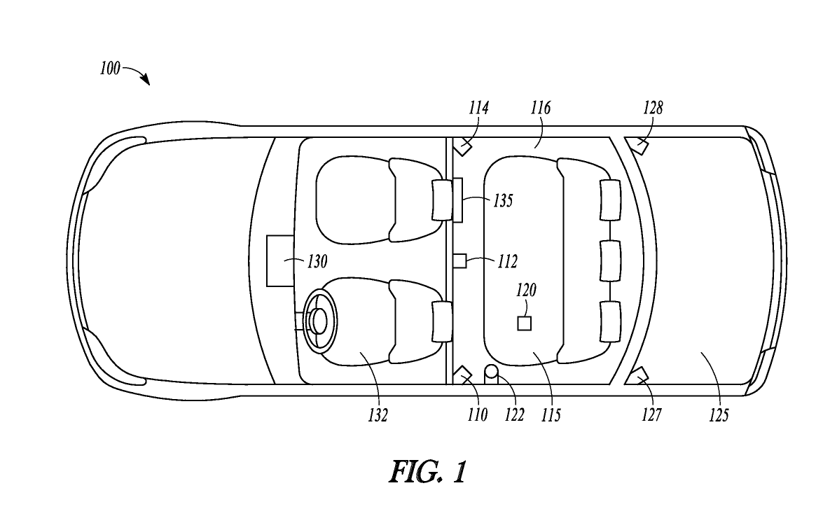

FIG. 1 is a top view of an inside of a taxi 100. Taxi 100 is one example of an area to be monitored for significant differences following use of the area by a customer. Taxi 100 includes a seating area 105 which includes multiple cameras 110, 112, 114 positioned to capture images of seating area 105 both before use of the area and after use of the area. In some embodiments, a single camera 112 may be used having a field of view that is suitable to capture an image that covers a seating area 115 and floor 116 in front of the seating area 115. Such a field of view is likely to include areas where a customer item, such as a cell phone 120, may be left behind. In some embodiments, camera 112 may cover areas that are more likely to be damaged, such as by liquid stains or structural damage such as a broken cup holder 122 or a rip in the seating area 115 fabric or other damage to the area such the interior of the vehicle or room. The use of all three or more cameras may provide for coverage of more areas that might be damaged, or where items might be left behind in further embodiments.

A trunk area 125 may also have cameras 127, 128 positioned to capture images of items left behind by a customer in the trunk of the taxi 100 in further embodiments. The cameras may be coupled to provide images to a computer 130, which may be located in a driver area 132 of the taxi 100. The computer 130 may be programmed to capture images via the cameras of the monitored areas prior to entry of a customer and just after the customer leaves or ceases using the areas. These times may be triggered by the driver in some embodiments via a touchscreen interface of computer 130. Upon capture of the post use image or images, the computer 130 may run image analytics software to identify differences between the images. Processing may alternatively or in addition may be performed via networked computers, such as server or cloud based system.

The differences may be further analyzed by performing object recognition algorithms, which in one embodiment will identify cell phone 120 as having been left behind by the customer and generate a notification. The notification may be provided by audible and/or visible alarms, tones, or sounds which may be conveyed to the customer via a display/speaker 135 positioned in the taxi between the seating area 115 and driver area 132. The display 135 may be supported on a barrier between the two areas and facing the seating area 115. Further notifications may include SMS messages or emails to one or both of the customer and an employee or driver. In the case of other types of areas, such as bus seating, airplane seating, bathrooms, conference rooms, etc., the notice may be provided to nearby employees and/or users of such areas. While the term “customer” is used to describe example embodiments, the term may encompass workers or other persons using an area, whether or not they are a paying customer.

In one embodiment, notification may be provided if the differences between the pre and post image or sets of images are significant. The image differences may be identified, isolated to portions of the image where they appear, and processed via image analytics to identify items in the post-use images that were not in the pre-use images. The identification may including identifying the one or more items as a wallet, purse, cell phone, tablet, backpack, ring, memory stick, key, credit card, or other type of item, which is categorized as significant. Other items that may not be specifically identified may be categorized as significant may include items that exceed a specified size minimum such as items having at least one dimension larger than one or two inches. In further embodiments, significant differences may include damage to the area, such as liquid stains, broken handles, knobs, and cup holders, and other damage.

In still further embodiments, trash may be identified, such as a newspaper or cup, and a notification to that effect may be provided to the driver or other employee responsible for keeping the area clean.

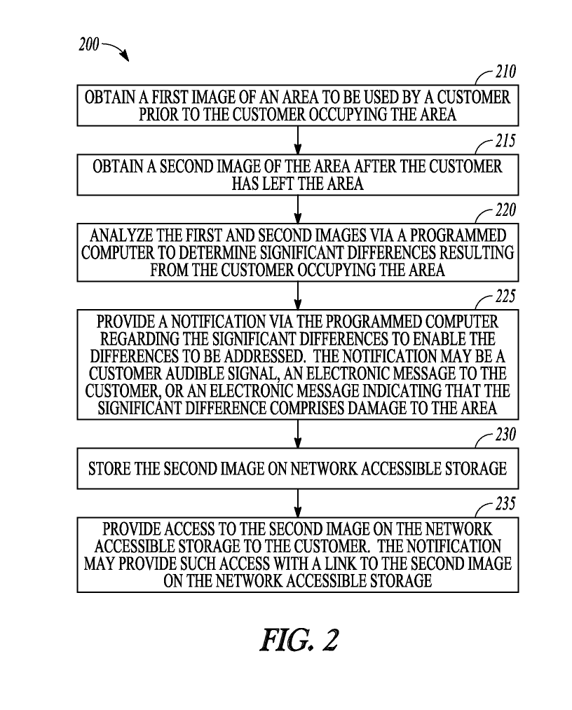

FIG. 2 is a flowchart illustrating a method 200 of identifying items remaining in an area after use by a customer in an example embodiment. Method 200 starts at 210 by obtaining a first image of an area to be used by a customer prior to the customer occupying the area. In various embodiments, the image may include one or more images from one or more cameras with different fields of view of the area covering different portions of the area taken just prior to a customer occupying the area. The area may be a seating area, storage area, or both in various embodiments. The image acquisition may be initiated by an employee responsible for the area in one embodiment with knowledge of when the area will be occupied. The initiation may also occur when a door restricting access to the area is opened. In still further embodiments, images may be obtained periodically, time stamped, and later correlated to times just before occupancy and just after occupancy. Image analytics may be used to determine when the area is occupied.

At 215, a second image of the area after the customer has left the area is obtained. The first and second images are analyzed via a programmed computer, also referred to as an information handling system, to determine significant differences resulting from the customer occupying the area at 220. In one embodiment, differences in the first and second images are easily identified and isolated to a set of pixels for each difference. The sets of pixels correspond to images of each of the items, which may be compared to images of items that are routinely left behind in a vehicle or conference room or other area. Such items may include wallets, purses, credit cards, tablet computers, cell phones and other commonly left behind items.

In a further embodiment, a significant difference might include a notable difference between the two images without identification of the source of the difference. The notable difference may include an area that changed in appearance between the pre and post occupancy images. The size of the area may be as small as one or two inches, or larger. The same items identified above, if left in the area, may result in such a notable difference. Items of clothing, such as glove, coat, or scarf may also either be identified, or result in such a notable difference.

At 225, a notification may be provided via the programmed computers regarding the significant differences to enable the differences to be addressed. The notification may be a customer audible signal, an electronic message to the customer, or an electronic message indicating that the significant difference comprises damage to the area.

Determining that a customer has left the area may be performed by use of a simple motion detector to detect that no motion is occurring may be used in one embodiment to trigger capturing of the second image. As previously discussed, image analytics of periodically captured images may be used to determine that a customer is no longer in an area, and that the first such image shall be designated the second image. Note that when it is detected that the customer has vacated an area designed for holding customers, any associated storage compartments may also be imaged and checked, with appropriate notifications provided.

In one embodiment, additional operations may be performed in method 200. At 230, the second image may be stored on network accessible storage. At 235, access to the second image on the network accessible storage may be provided to the customer. The notification may provide such access with a link to the second image on the network accessible storage.

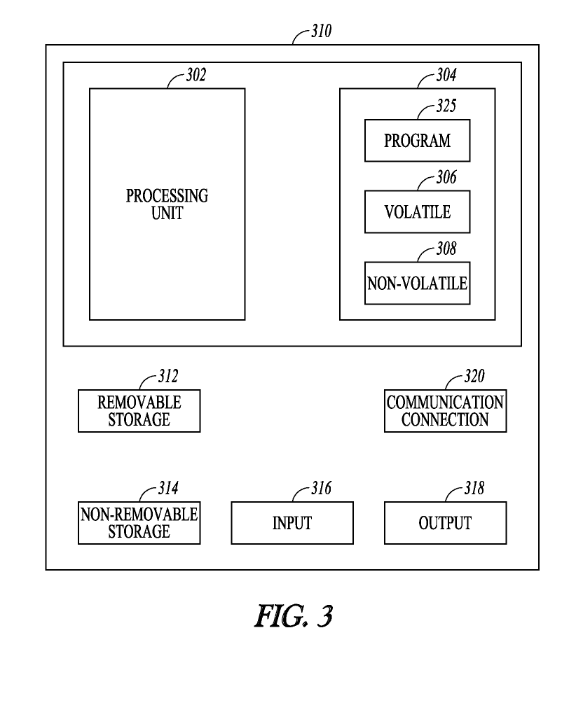

FIG. 3 is a block schematic diagram of a computer system 300 to implement the processor and memory of the mobile device, as well as executing methods according to example embodiments. All components need not be used in various embodiments. One example computing device in the form of a computer 300, may include a processing unit 302, memory 303, removable storage 310, and non-removable storage 312. Although the example computing device is illustrated and described as computer 300, the computing device may be in different forms in different embodiments. For example, the computing device may instead be a smartphone, a tablet, smartwatch, or other computing device including the same or similar elements as illustrated and described with regard to FIG. 3. Devices such as smartphones, tablets, and smartwatches are generally collectively referred to as mobile devices. Further, although the various data storage elements are illustrated as part of the computer 300, the storage may also or alternatively include cloud-based storage accessible via a network, such as the Internet.

Memory 303 may include volatile memory 314 and non-volatile memory 308. Computer 300 may include—or have access to a computing environment that includes—a variety of computer-readable media, such as volatile memory 314 and non-volatile memory 308, removable storage 310 and non-removable storage 312. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

Computer 300 may include or have access to a computing environment that includes input 306, output 304, and a communication connection 316. Output 304 may include a display device, such as a touchscreen, that also may serve as an input device. The input 306 may include one or more of a touchscreen, touchpad, mouse, keyboard, camera, one or more device-specific buttons, one or more sensors integrated within or coupled via wired or wireless data connections to the computer 300, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable storage device are executable by the processing unit 302 of the computer 300. A hard drive, CD-ROM, and RAM are some examples of articles including a non-transitory computer-readable medium such as a storage device. The terms computer-readable medium and storage device do not include carrier waves. For example, a computer program 318 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 300 to provide generic access controls in a COM based computer network system having multiple users and servers.

### EXAMPLES

1. A method comprising:

obtaining a first image of an area to be used by a customer prior to the customer occupying the area;

obtaining a second image of the area after the customer has left the area;

analyzing the first and second images via an information handling system to determine significant differences resulting from the customer occupying the area; and

providing a notification via the information handling system regarding the significant differences to enable the differences to be addressed.

2. The method of example 1 wherein the first image comprises a first set of images of different portions of the area and the second image comprises a second set of images of different portions of the area.

3. The method of any of examples 1-2 wherein the image analysis comprises recognizing a mobile device in the second image that was not in the first image, said recognized mobile device comprising a significant difference.

4. The method of any of examples 1-3 wherein a significant difference comprises a purse or wallet appearing in the second image but not in the first image.

5. The method of any of examples 1-4 wherein a significant difference comprises damage to the area appearing the second image but not in the first image.

6. The method of any of examples 1-5 wherein the notification comprises a customer audible signal.

7. The method of any of examples 1-6 wherein the notification comprises an electronic message to the customer.

8. The method of any of examples 1-7 wherein the notification comprises an electronic message indicating that the significant difference comprises damage to the area.

9. The method of any of examples 1-8 and further comprising detecting that a customer has vacated the area to trigger obtaining the second image.

10. The method of any of examples 1-9 wherein the first and second images are time stamped.

11. The method of any of examples 1-10 and further comprising:

storing the second image on network accessible storage; and

providing access to the second image on the network accessible storage to the customer, wherein the notification is provided with a link to the second image on the network accessible storage.

12. A computing device comprising:

a processor; and

a memory device coupled to the processor having instructions stored thereon executable by the processor to:
obtain a first image of an area to be used by a customer prior to the customer occupying the area;
obtain a second image of the area after the customer has left the area;
analyze the first and second images via an information handling system to determine significant differences resulting from the customer occupying the area; and
provide a notification via the information handling system regarding the significant differences to enable the differences to be addressed.

13. The computing device of example 12 and further comprising a camera coupled to generate the first and second images of the area and provide them to the memory device.

14. The computing device of any of examples 12-13 wherein the first image comprises a first set of images of different portions of the area and the second image comprises a second set of images of different portions of the area.

15. The computing device of any of examples 12-14 wherein a significant difference comprises a mobile electronic device, purse, or wallet appearing in the second image but not in the first image.

16. The computing device of any of examples 12-15 wherein a significant difference comprises damage to the area appearing the second image but not in the first image and wherein the notification comprises an electronic message indicating that the significant difference comprises such damage.

17. The computing device of any of examples 12-16 wherein the instructions stored thereon are further executable by the processor to:

store the second image on network accessible storage; and

provide access to the second image on the network accessible storage to the customer, wherein the notification is provided with a link to the second image on the network accessible storage.

18. A machine readable storage device having instructions that are executable by a processor to perform operations comprising:

obtaining a first image of an area to be used by a customer prior to the customer occupying the area;

obtaining a second image of the area after the customer has left the area;

analyzing the first and second images via an information handling system to determine significant differences resulting from the customer occupying the area; and

providing a notification via the information handling system regarding the significant differences to enable the differences to be addressed.

19. The information handling device readable storage device of example 18 wherein the notification comprises a customer audible signal.

20. The information handling device readable storage device of any of examples 18-20 wherein the operations further comprise:

storing the second image on network accessible storage; and

providing access to the second image on the network accessible storage to the customer, wherein the notification is provided with a link to the second image on the network accessible storage.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
obtaining a first image of an area to be used by a customer prior to the customer occupying the area;
obtaining a second image of the area after the customer has left the area;
analyzing the first and second images via an information handling system to determine significant differences resulting from the customer occupying the area; and
providing a notification via the information handling system regarding the significant differences to enable the differences to be addressed.

2. The method of claim 1 wherein the first image comprises a first set of images of different portions of the area and the second image comprises a second set of images of different portions of the area.

3. The method of claim 1 wherein the image analysis comprises recognizing a mobile device in the second image that was not in the first image, said recognized mobile device comprising a significant difference.

4. The method of claim 1 wherein a significant difference comprises a purse or wallet appearing in the second image but not in the first image.

5. The method of claim 1 wherein a significant difference comprises damage to the area appearing the second image but not in the first image.

6. The method of claim 1 wherein the notification comprises a customer audible signal.

7. The method of claim 1 wherein the notification comprises an electronic message to the customer.

8. The method of claim 1 wherein the notification comprises an electronic message indicating that the significant difference comprises damage to the area.

9. The method of claim 1 and further comprising detecting that a customer has vacated the area to trigger obtaining the second image.

10. The method of claim 1 wherein the first and second images are time stamped.

11. The method of claim 1 and further comprising:
storing the second image on network accessible storage; and
providing access to the second image on the network accessible storage to the customer, wherein the notification is provided with a link to the second image on the network accessible storage.

12. A computing device comprising:
a processor; and
a memory device coupled to the processor having instructions stored thereon executable by the processor to:
obtain a first image of an area to be used by a customer prior to the customer occupying the area;
obtain a second image of the area after the customer has left the area;
analyze the first and second images via an information handling system to determine significant differences resulting from the customer occupying the area; and
provide a notification via the information handling system regarding the significant differences to enable the differences to be addressed.

13. The computing device of claim 12 and further comprising a camera coupled to generate the first and second images of the area and provide them to the memory device.

14. The computing device of claim 12 wherein the first image comprises a first set of images of different portions of the area and the second image comprises a second set of images of different portions of the area.

15. The computing device of claim 12 wherein a significant difference comprises a mobile electronic device, purse, or wallet appearing in the second image but not in the first image.

16. The computing device of claim 12 wherein a significant difference comprises damage to the area appearing the second image but not in the first image and wherein the notification comprises an electronic message indicating that the significant difference comprises such damage.

17. The computing device of claim 12 wherein the instructions stored thereon are further executable by the processor to:
store the second image on network accessible storage; and
provide access to the second image on the network accessible storage to the customer, wherein the notification is provided with a link to the second image on the network accessible storage.

18. A machine readable storage device having instructions that are executable by a processor to perform operations comprising:
obtaining a first image of an area to be used by a customer prior to the customer occupying the area;
obtaining a second image of the area after the customer has left the area;
analyzing the first and second images via an information handling system to determine significant differences resulting from the customer occupying the area; and
providing a notification via the information handling system regarding the significant differences to enable the differences to be addressed.

19. The information handling device readable storage device of claim 18 wherein the notification comprises a customer audible signal.

20. The information handling device readable storage device of claim 18 wherein the operations further comprise:
storing the second image on network accessible storage; and
providing access to the second image on the network accessible storage to the customer, wherein the notification is provided with a link to the second image on the network accessible storage.
